(19) United States
(12) Patent Application Publication
(10) Pub. No.: US 2014/0129284 A1
(43) Pub. Date: May 8, 2014

(54) Real-Time System Processing Capability Determination and Workflow Adaptation for Target Regions in a Customer Information Control System

(71) Applicant: FMR LLC, Boston, MA (US)

(72) Inventors: Thom Rexrode, Chapel Hill, NC (US); Mary Hilchey, Stoughton, MA (US)

(73) Assignee: FMR LLC, Boston, MA (US)

(21) Appl. No.: 13/671,183

(22) Filed: Nov. 7, 2012

(51) Int. Cl. G06Q 10/06

(52) U.S. Cl. CPC G06Q 10/06316
USPC 705/7.26

(57) ABSTRACT

Methods and apparatuses are described for real-time system processing capability determination and workflow adaptation for target regions in a customer information control system. A target region computing device detects a condition in a target region. The computing device publishes a global data element to a list upon detecting the condition, where the global data element includes an identifier associated with the target region and an identifier associated with the detected condition. The gateway receives a workflow request that is compatible with a plurality of target regions including the target region and executes one or more actions based on the workflow request and the detected condition.

### FIELD OF THE INVENTION

The subject matter of this application relates generally to methods and apparatuses, including computer program products, for real-time system processing capability determination and workflow adaptation for target regions in a customer information control system.

### BACKGROUND OF THE INVENTION

Customer information control systems, or CICS, relates to systems and software originally developed by IBM, Inc. and generally consists of a family of application servers and connectors that provides industrial-strength, online transaction management and connectivity for mission-critical applications (e.g., IBM® CICS® Transaction Server for z/OS® (CICS TS) V5.1). Customer information control systems are designed to process a large number of transactions that require a diverse range of applications and functions, at a high speed—while maintaining the management of the entire transaction (e.g., for monitoring and quality control).

An exemplary industry that implements customer information control systems is brokerage services. Due to the large number of trades and associated account transactions that are requested in a given time period along with the variety of applications and functions (e.g., accounting, clearance, transfers, etc.) that the trades require, a customer information control system allows for fast and efficient processing of the functions and related data.

### SUMMARY OF THE INVENTION

Because a customer information control system processes so many transactions across a network of distributed regions, each having distinct computing devices and applications, the stability and processing workload of the system is crucial to preserving the reliability and efficiency of the system. Sometimes, certain regions in the system experience unhealthy processing conditions. For example, a region in the customer information control system may experience a shortage of storage available for use by the applications in that region. This condition may affect the ability of the region to process additional transactions as they are received. In another example, a region may instantiate multiple calls to the same function or to functions of the same type. The function may be subject to a limit on how many instances can execute at a given time, and subsequent transactions that require this function may be delayed or unable to complete.

Therefore, improved methods and systems are needed for real-time system processing capability determination and workflow adaptation for target regions in a customer information control system. The techniques allow the system to detect such unhealthy conditions at the target region level, and adjust the processing and distribution of transactions (or workflow requests) at both the target region level and the gateway level to ensure that subsequent transactions can be processed by the system without causing interruption, delay, or failure.

The invention, in one aspect, features a method for real-time system processing capability determination and workflow adaptation for target regions in a customer information control system. A target region computing device of the customer information control system detects a short-on-storage condition in a target region. The target region computing device publishes a global data element to a list upon detecting the short-on-storage condition, where the global data element includes an identifier associated with the target region and an identifier associated with the detected condition. A gateway of the customer information control system changes a workflow status entry for the target region from an active state to an excluded state upon determining that the list includes the global data element associated with the target region. The gateway receives a workflow request that is compatible with a plurality of target regions including the target region and determines that the workflow status entry for the target region is set to the excluded state. The gateway prevents the target region from receiving the workflow request.

The invention, in another aspect, features a customer information control system configured for real-time system processing capability determination and workflow adaptation for target regions. The system includes one or more target region computing devices configured to detect a short-on-storage condition in the target region, and publish a global data element to a list upon detecting the short-on-storage condition, wherein the global data element includes an identifier associated with the target region and an identifier associated with the detected condition. The system includes a gateway configured to change a workflow status entry for the target region from an active state to an excluded state upon determining that the list includes the global data element associated with the target region, receive a workflow request that is compatible with a plurality of target regions including the target region, determine that the workflow status entry for the target region is set to excluded, and prevent the target region from receiving the workflow request. The system includes a network coupling the gateway and the one or more target region computing devices.

The invention, in another aspect, features a method for real-time system processing capability determination and workflow adaptation for target regions in a customer information control system. A target region computing device of the customer information control system detects a tranclass condition in a target region. The target region computing device publishes a global data element upon detecting the tranclass condition, where the global data element includes an identifier associated with the target region and an identifier associated with the detected condition. A gateway of the customer information control system receives a workflow request that is compatible with a plurality of target regions including the target region. The gateway generates a workflow priority list including the plurality of target regions. The gateway sorts the workflow priority list to place the target region associated with the global data element at the bottom of the priority list. The gateway transmits the workflow request to one of the plurality of target regions based on the workflow priority list.

The invention, in another aspect, features a customer information control system configured for real-time system processing capability determination and workflow adaptation for target regions. The system includes one or more target region computing devices configured to detect a tranclass condition in the target region, and publish a global data element upon detecting the tranclass condition, where the global data element includes an identifier associated with the target region and an identifier associated with the detected condition. The system includes a gateway configured to receive a workflow request that is compatible with a plurality of target regions including the target region, generate a workflow priority list including the plurality of target regions, sort the workflow priority list to place the target region associated with the global data element at the bottom of the priority list, and transmit the workflow request to one of the plurality of target regions based on the workflow priority list. The system includes a network coupling the gateway and the one or more target region computing devices.

In some embodiments, any of the above aspects can include one or more of the following features. In some embodiments, the target region computing device removes the global data element from the list upon detecting that the short-on-storage condition is resolved in the target region, the gateway changes the workflow status entry for the target region from excluded to active upon determining that the global data element associated with the target region is removed from the list and enables the target region to receive subsequent workflow requests. In some embodiments, the list is stored at a coupling facility in the customer information control system.

In some embodiments, the detecting step is performed by a long-running transaction executing in the target region computing device. In some embodiments, the long-running transaction continually polls the target region to detect the short-on-storage condition. In some embodiments, the workflow status entry is located in a user-maintained data table. In some embodiments, the identifier associated with the target region corresponds to the name of the target region.

In some embodiments, the target region computing device transmits an alert to a remote computing device upon detecting the short-on-storage condition. In some embodiments, the target region computing device transmits an alert to a remote computing device upon detecting that the short-on-storage condition is resolved in the target region. In some embodiments, the workflow status entry for the target region is changed from an active state to an excluded state only after a predetermined storage threshold is met.

In some embodiments, the target region computing device removes the global data element upon detecting that the tranclass condition is resolved in the target region. In some embodiments, the global data element is stored at a coupling facility in the customer information control system. In some embodiments, the long-running transaction continually polls the target region to detect the tranclass condition.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a customer information control system for real-time system processing capability determination and workflow adaptation for target regions.

FIG. 2 is a flow diagram of a method for real-time system processing capability determination and workflow adaptation, including short-on-storage condition detection, for target regions in a customer information control system.

FIG. 3 is a flow diagram of a method for real-time system processing capability determination and workflow adaptation, including tranclass condition detection, for target regions in a customer information control system.

### DETAILED DESCRIPTION

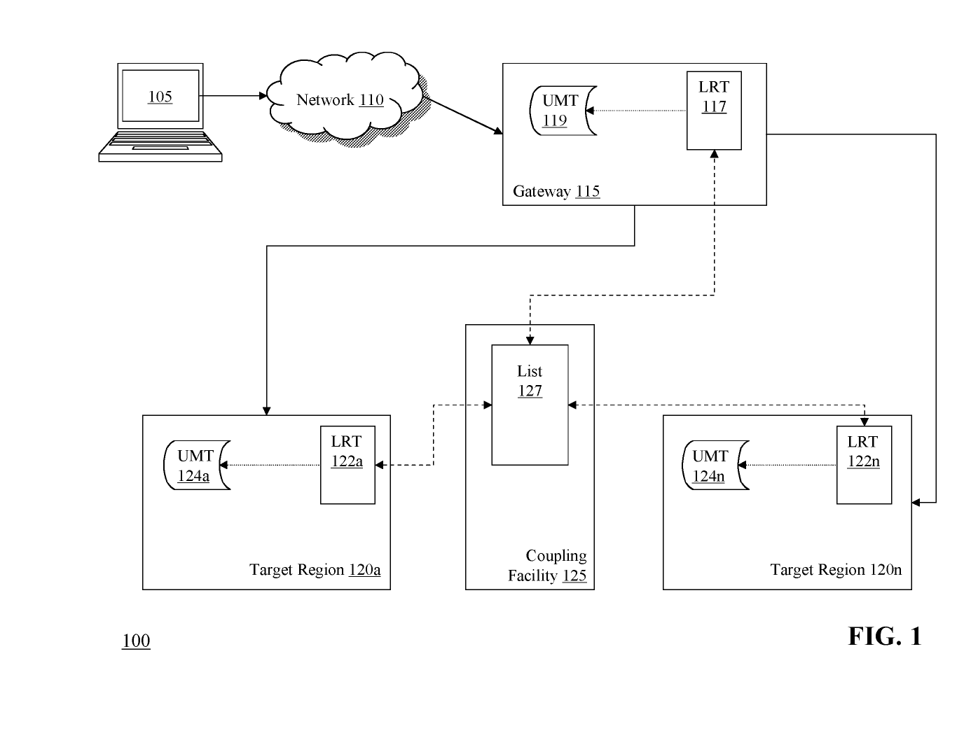

FIG. 1 is a block diagram of a customer information control system 100 for real-time system processing capability determination and workflow adaptation for target regions (e.g., target regions 120a and 120n). The system 100 includes a requestor computing device 105, a communications network 110, a gateway 115, a plurality of target regions 120a and 120n, and a coupling facility 125. The requestor computing device 105 can establish a communication session with the gateway 115 via the network 110 and using standard communication protocols (e.g., TCP/IP) and related techniques. Although FIG. 1 depicts only a requestor computing device 105, a single network 110, and a single gateway device 115, the techniques described herein are not limited to this structure. Instead, this system 100 can include any of a number of configurations or components (e.g., multiple requestor computing devices, multiple gateways, and/or multiple communications networks) that do not depart from the scope of the invention. Also, in some embodiments, the requestor computing device 105 executes middleware software (e.g., MAUI) and acts an interface between the gateway 115 and other computing devices and/or networks (such as a website user interface) that can submit workflow requests to the system 100. Other examples of requestor computing devices are WebSphere® application servers, Java®-based servers, devices running C/C++, .NET or other similar software applications, other CICS systems, and the like.

The gateway 115 is a computing device that receives workflow requests from a requestor computing device 105 and transmits the workflow requests to the target regions 120a, 120n of the customer information control system 100. The gateway 115 manages distribution of the workflow requests to the target regions 120a, 120n to ensure efficient processing of the requests and to balance the requests appropriately across the target regions 120a, 120n. The gateway 115 can be configured to monitor certain characteristics of the target regions 120a, 120n, including but not limited to workload status, activity, capacity, errors, and failures. The gateway 115 can be configured, for example, to execute IBM® CICS Transaction Gateway v9.0 software, available from IBM, Inc.

The target regions 120a, 120n (also called application-owning regions or AORs) include one or more computing devices that manage applications and corresponding data within the respective target regions 120a, 120n. In some embodiments, each of the target regions 120a, 120n is allocated to handle a particular business function or transaction. Due to its distributed nature, the system 100 is designed to process a large number of transactions with efficiency and speed. Also, there can be multiple target regions 120a, 120n that can handle the same types of functions or transactions, for redundancy purposes. Although FIG. 1 depicts only two target regions 120a, 120n, it should be understood that the system 100 can include any number of target regions without departing from the scope of the invention.

In some embodiments, the system 100 includes a coupling facility 125. The coupling facility 125 is a physical or logical module that is capable of providing functionality to the gateway 115 and target regions 120a, 120n. Such functionality includes, but is not limited to, high-speed caching of data, list structure, and locking features. The coupling facility 125 can be located on a separate computing device from the target regions 120a, 120n, or the coupling facility 125 can be integrated into the computing device(s) of the target regions 120a, 120n or the gateway 115. The coupling facility 125 includes a list 127 that contains status entries for each of the connected target regions 120a, 120n. The status entries can indicate workload status, activity, capacity, errors, and failures, among other things, for each of the target regions 120a, 120n.

The gateway 115 and the target regions 120a, 120n each executes a long-running task (LRT) 117, 122a, and 122n, respectively, that is associated with the techniques described herein. The LRT 117, 122a, 122n is a software module that is capable of calling related application programming interface (API) programs to perform specific tasks. The LRT 117, 122a, 122n can also pass data to the API programs as part of the call.

The gateway 115 and the target regions 120a, 120n each includes a user-maintained data table (UMT) 117, 124a, and 124n, respectively. The UMTs 117, 124a, 124n are generated to separate the data table from the underlying data, i.e., when the UMT is updated the underlying data set is not changed. The UMTs can be used to store data that may be transitory in nature.

As described above, the target regions 120a, 120n receive transactions from the gateway 115 for processing. Because the regions 120a, 120n are generally responsible for processing a large number of transactions, certain unhealthy conditions can arise that affect the processing efficiency and capability of the region(s). For example, application functions in target region 120a may attempt to acquire storage as part of their processing, and the target region 120a may not have enough storage to satisfy the acquisition request. In this example, the target region 120a is identified as having a short-on-storage condition. In another example, application functions in the target region 120n may have instantiated a number of transactions that belong to the same transaction class, such that the number of instantiated transactions has exceeded a predetermined limit. In this example, the target region 120n is identified as having a tranclass condition. The techniques described herein detect such unhealthy conditions and adjust workflow processing for the system 100 to account for the unhealthy conditions until such time as they are resolved.

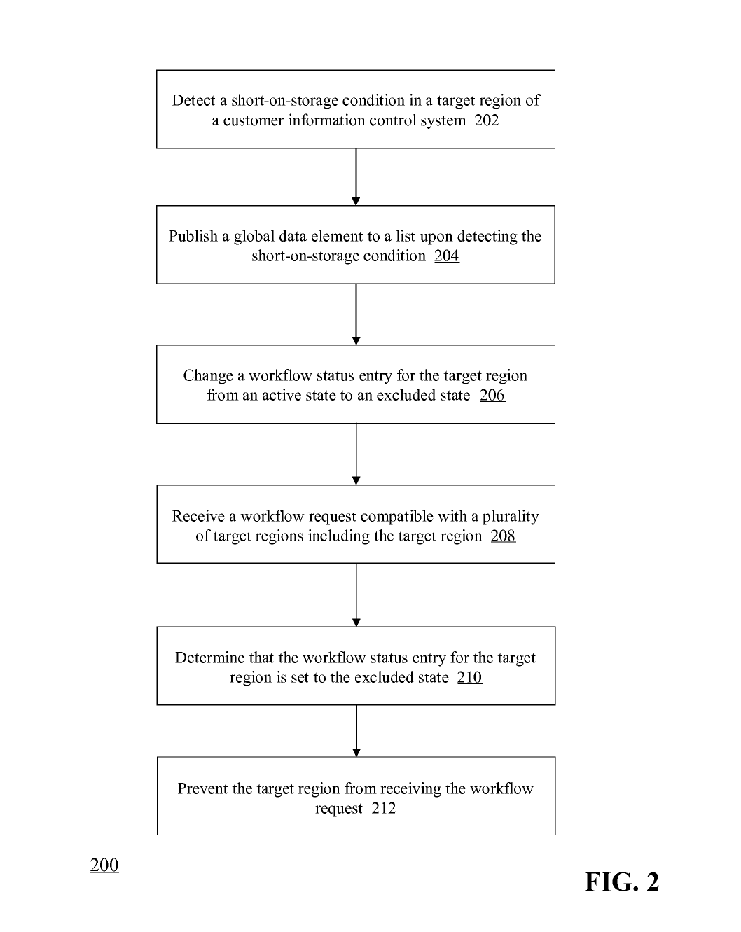

FIG. 2 is a flow diagram of a method 200 for real-time system processing capability determination and workflow adaptation, including short-on-storage condition detection, for target regions in the customer information control system 100 of FIG. 1. On normal operation, the target regions 120a, 120n receive workflow requests from the gateway 115 (as submitted by the requestor computing device 105) for processing. The LRTs 122a, 122n execute on computing devices of the respective target regions 120a, 120n and monitor the target regions for the existence of potential unhealthy conditions (e.g., short-on-storage).

The LRT (e.g., LRT 122a) of a target region (e.g., region 120a) periodically executes an API program to perform the monitoring of the target region 120a. The API program detects (202) a short-on-storage condition existing in the target region 120a by receiving a notification via a system inquiry command that the region 120a is short on dynamic storage (also called virtual storage) either above, below, or above and below a particular storage amount (e.g., 16 MB). In some embodiments, the API program transmits an alert to a remote computing device (e.g., a computer used by personnel to monitor performance and health of the system 100) upon detecting the short-on-storage condition.

The affected target region 120a publishes (204) a global data element upon detecting the short-on-storage condition by transmitting the global data element to the coupling facility 125. In some embodiments, the coupling facility 125 stores the global data element in a list 127 for reference by other computing devices in the system 100 (e.g., gateway 115, target region 120n, etc.). The global data element includes an identifier associated with the target region and an identifier associated with the detected short-on-storage condition. For example, the global data element can have a unique naming convention that the system 100 identifies as related to a short-on-storage condition, and the region name (or other identifying information) can be embedded in the global data element name as part of the naming convention. In some embodiments, the global data element also includes a timestamp associated with detection of the unhealthy condition.

The LRT 122a and API program of the affected target region 120a also changes (206) a workflow status entry associated with the region 120a from an active state to an excluded state upon detecting the short-on-storage condition. An active state indicates that the region is eligible to receive further workflow requests, while an excluded state indicates that the region should be prevented from receiving any further workflow requests until the condition is resolved.

The gateway 115 polls the coupling facility 125 to determine status for each of the target regions 120a, 120n. As part of the polling process, the gateway 115 retrieves the list 127. Based on the list 127, the gateway 115 determines whether specific target region(s) are subject to unhealthy processing conditions and can route incoming workflow requests to the target regions 120a, 120n as appropriate given the known conditions. For those target regions that are experiencing a short-on-storage condition, the gateway 115 changes a workflow status entry in the associated UMT 119 from an active state to an excluded state.

The gateway 115 receives (208) a workflow request from a requestor computing device 105 via a network 110. The workflow request is compatible with a plurality of target regions—that is, the request is associated with a function that can be performed by or an application that is available at more than one target region. The identity of the compatible target regions includes one or more of target regions 120a, 120n. After receiving the workflow request, the gateway 115 analyzes the UMT 119 to determine (210) whether any of the compatible target regions has a workflow status entry that is set to an excluded state. The gateway 115 prevents (212) the excluded target region(s) from receiving the workflow request, and routes the request to a compatible target region that is active.

Subsequently, the LRT 122a at the computing device in the affected target region (e.g., region 120a) executes the API program and, if the short-on-storage condition is resolved, the API program detects that the short-on-storage condition no longer exists and removes the global data element from the list 127 at the coupling facility 125. The API program also changes the workflow status entry in the UMT 124a for the target region 120a from an excluded state to an active state. In some embodiments, the computing device of the target region 120a transmits an alert to a remote computing device (e.g., a computer used by personnel to monitor performance and health of the system 100) upon detecting that the short-on-storage condition has been resolved.

As described above, the gateway 115 polls the coupling facility 125 and retrieves the list 127. Because the target region 120a does not appear on the list 127 with respect to a short-on-storage condition, the LRT 117 at the gateway 115 executes an API program to change the workflow status entry in the UMT 119 from an excluded state to an active state—enabling the target region 120a to be eligible to receive subsequent compatible workflow requests.

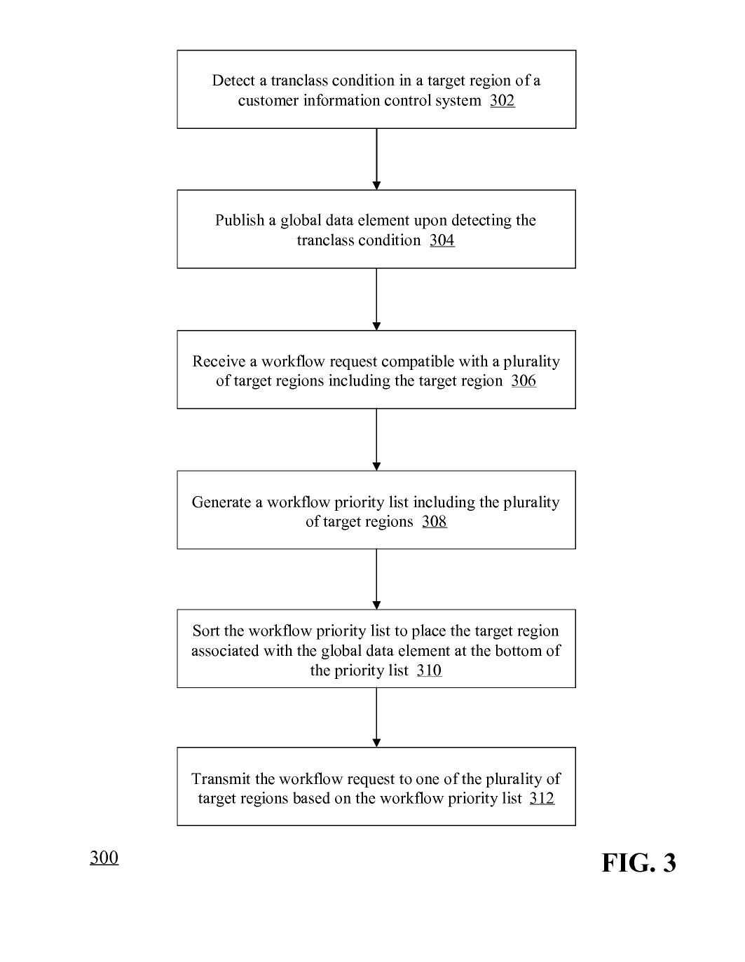

Another type of condition that can impact the health of the system 100 is a tranclass condition. FIG. 3 is a flow diagram of a method 300 for real-time system processing capability determination and workflow adaptation, including tranclass condition detection, for target regions in the system 100 of FIG. 1.

As previously described, on normal operation, the target regions 120a, 120n receive workflow requests from the gateway 115 (as submitted by the requestor computing device 105) for processing. The LRTs 122a, 122n execute on computing devices of the respective target regions 120a, 120n and monitor the target regions for the existence of potential unhealthy conditions (e.g., short-on-storage).

The LRT (e.g., LRT 122a) of a target region (e.g., region 120a) periodically executes an API program to perform the monitoring of the target region 120a. The API program detects (302) a tranclass condition existing in the target region 120a if the number of instances of a specific transaction executing on the target region 120a exceeds a predetermined threshold. In some embodiments, the API program transmits an alert to a remote computing device (e.g., a computer used by personnel to monitor performance and health of the system 100) upon detecting the tranclass condition.

The affected target region 120a publishes (304) a global data element upon detecting the tranclass condition. In some embodiments, the target region 120a transmits the global data element to the coupling facility 125, and the coupling facility 125 stores the global data element in a list 127 for reference by other computing devices in the system 100 (e.g., gateway 115, target region 120n, etc.). In some embodiments, the target region 120a transmits the global data element directly to other computing devices in the system 100.

The global data element includes an identifier associated with the target region and an identifier associated with the detected tranclass condition. For example, the global data element can have a unique naming convention that the system 100 identifies as related to a tranclass condition, and the region name (or other identifying information) can be embedded in the global data element name as part of the naming convention. In some embodiments, the global data element also includes a timestamp associated with detection of the unhealthy condition.

In some embodiments, the gateway 115 polls the coupling facility 125 to determine status for each of the target regions 120a, 120n. As part of the polling process, the gateway 115 retrieves the list 127. Based on the list 127, the gateway 115 determines whether specific target region(s) are subject to unhealthy processing conditions and can route incoming workflow requests to the target regions 120a, 120n as appropriate given the known conditions.

The gateway 115 receives (306) a workflow request from a requestor computing device 105 via a network 110. The workflow request is compatible with a plurality of target regions—that is, the request is associated with a function that can be performed by or an application that is available at more than one target region. The identity of the compatible target regions includes one or more of target regions 120a, 120n.

After receiving the workflow request, the gateway 115 generates (308) a workflow priority list that includes the plurality of compatible target regions. In some embodiments, the workflow priority list is generated at an earlier time (e.g., at startup of the system 100) and maintained by the gateway 115 to account for changing conditions in the system 100. The gateway 115 sorts (310) the workflow priority list to place the target region associated with the global data element (meaning the region affected by the tranclass condition) at the bottom of the priority list. The affected region 120a is still eligible to receive a workflow request, but other non-affected regions are preferred in the priority list. The gateway transmits (312) the workflow request to one of the plurality of target regions based on the workflow priority list.

Subsequently, the LRT 122a at the computing device in the affected target region (e.g., region 120a) executes the API program and, if the tranclass condition is resolved, the API program detects that the tranclass condition no longer exists and removes the global data element. For example, the API program removes the global data element from the list 127 at the coupling facility 125.

Because the target region 120a is no longer experiencing a tranclass condition, the LRT 117 at the gateway 115 can re-sort the workflow priority list to account for the change in condition. As a result, the target region 120a may receive priority over other non-affected target regions to receive subsequent compatible workflow requests.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein.

1. A method for real-time system processing capability determination and workflow adaptation for target regions in a customer information control system, the method comprising:
detecting, by a target region computing device of the customer information control system, a short-on-storage condition in a target region;
publishing, by the target region computing device, a global data element to a list upon detecting the short-on-storage condition, wherein the global data element includes an identifier associated with the target region and an identifier associated with the detected condition;
changing, by a gateway of the customer information control system, a workflow status entry for the target region from an active state to an excluded state upon determining that the list includes the global data element associated with the target region;
receiving, by the gateway, a workflow request that is compatible with a plurality of target regions including the target region;
determining, by the gateway, that the workflow status entry for the target region is set to the excluded state; and
preventing, by the gateway, the target region from receiving the workflow request.

2. The method of claim 1, further comprising:
removing, by the target region computing device, the global data element from the list upon detecting that the short-on-storage condition is resolved in the target region;
changing, by the gateway, the workflow status entry for the target region from excluded to active upon determining that the global data element associated with the target region is removed from the list; and
enabling, by the gateway, the target region to receive subsequent workflow requests.

3. The method of claim 1, wherein the list is stored at a coupling facility in the customer information control system.

4. The method of claim 1, wherein the detecting step is performed by a long-running transaction executing in the target region computing device.

5. The method of claim 4, wherein the long-running transaction continually polls the target region to detect the short-on-storage condition.

6. The method of claim 1, wherein the workflow status entry is located in a user-maintained data table.

7. The method of claim 1, wherein the identifier associated with the target region corresponds to the name of the target region.

8. The method of claim 1, further comprising transmitting, by the target region computing device, an alert to a remote computing device upon detecting the short-on-storage condition.

9. The method of claim 1, further comprising transmitting, by the target region computing device, an alert to a remote computing device upon detecting that the short-on-storage condition is resolved in the target region.

10. The method of claim 1, wherein the workflow status entry for the target region is changed from an active state to an excluded state only after a predetermined storage threshold is met.

11. A method for real-time system processing capability determination and workflow adaptation for target regions in a customer information control system, the method comprising:
determining, by a target region computing device of the customer information control system, (i) one or more transaction classes and (ii) a number of active tasks for each transaction class;
transmitting, by the target region computing device, the one or more transaction classes and the number of active tasks for each transaction class to a gateway of the customer information control system;
detecting, by the target region computing device, a tranclass condition in a target region, wherein the tranclass condition occurs when the number of active tasks for a transaction class is above a predetermined maximum value for the transaction class;
publishing, by the target region computing device, a global data element upon detecting the tranclass condition, wherein the global data element includes an identifier associated with the target region, the one or more transaction classes, the number of active tasks for each transaction class, and an identifier associated with the detected condition;
receiving, by a gateway of the customer information control system, a workflow request associated with at least one of the transaction classes, wherein the request is compatible with a plurality of target regions including the target region;
generating, by the gateway, a workflow priority list including the plurality of target regions, the one or more transaction classes for each target region, and the number of active tasks for each transaction class;
sorting, by the gateway, the plurality of target regions in the workflow priority list based upon the one or more transaction classes for each target region and the number of active tasks for each transaction class; and
transmitting, by the gateway, the workflow request to one of the plurality of target regions based on the workflow priority list, where the target region.

12. The method of claim 11, further comprising removing, by the target region computing device, the global data element upon detecting that the tranclass condition is resolved in the target region.

13. The method of claim 11, wherein the global data element is stored at a coupling facility in the customer information control system.

14. The method of claim 11, wherein the detecting step is performed by a long-running transaction executing in the target region computing device.

15. The method of claim 14, wherein the long-running transaction continually polls the target region to detect the tranclass condition.

16. The method of claim 11, wherein the global data element is located in a user-maintained data table.

17. The method of claim 11, wherein the identifier associated with the target region corresponds to the name of the target region.

18. A customer information control system configured for real-time system processing capability determination and workflow adaptation for target regions, the system comprising:
one or more target region computing devices configured to:
detect a short-on-storage condition in the target region, and
publish a global data element to a list upon detecting the short-on-storage condition, wherein the global data element includes an identifier associated with the target region and an identifier associated with the detected condition;
a gateway configured to:
change a workflow status entry for the target region from an active state to an excluded state upon determining that the list includes the global data element associated with the target region,
receive a workflow request that is compatible with a plurality of target regions including the target region,
determine that the workflow status entry for the target region is set to excluded, and
prevent the target region from receiving the workflow request; and
a network coupling the gateway and the one or more target region computing devices.

19. The system of claim 18, wherein:
the target region computing devices are further configured to:
remove the global data element from the list upon detecting that the short-on-storage condition is resolved in the target region; and
the gateway is further configured to:
change the workflow status entry for the target region from excluded to active upon determining that the global data element associated with the target region is removed from the list; and
enable the target region to receive subsequent workflow requests.

20. The system of claim 18, further comprising:
a coupling facility located between the gateway and the one or more target regions, the coupling facility configured to store the list.

21. The system of claim 18, wherein the one or more target region computing devices execute a long-running transaction to perform the detecting.

22. The system of claim 21, wherein the long-running transaction continually polls the target region to detect the short-on-storage condition.

23. The system of claim 18, wherein the workflow status entry is located in a user-maintained data table.

24. The system of claim 18, wherein the identifier associated with the target region corresponds to the name of the target region.

25. The system of claim 18, the target region computing devices further configured to transmit an alert to a remote computing device upon detecting the short-on-storage condition.

26. The system of claim 18, the target region computing devices further configured to transmit an alert to a remote computing device upon detecting that the short-on-storage condition is resolved in the target region.

27. A customer information control system configured for real-time system processing capability determination and workflow adaptation for target regions, the system comprising:
one or more target region computing devices configured to:
determine (i) one or more transaction classes and (ii) a number of active tasks for each transaction class;
transmit the one or more transaction classes and the number of active tasks for each transaction class to a gateway of the customer information control system;
detect a tranclass condition in the target region, wherein the tranclass condition occurs when the number of active tasks for a transaction class is above a predetermined maximum value for the transaction class; and
publish a global data element upon detecting the tranclass condition, wherein the global data element includes an identifier associated with the target region, the one or more transaction classes, the number of active tasks for each transaction class, and an identifier associated with the detected condition;
a gateway configured to:
receive a workflow request associated with at least one of the transaction classes, wherein the request is compatible with a plurality of target regions including the target region;
generate a workflow priority list including the plurality of target regions, the one or more transaction classes for each target region, and the number of active tasks for each transaction class;
sort the plurality of target regions in the workflow priority list based upon the one or more transaction classes for each target region and the number of active tasks for each transaction class; and
transmit the workflow request to one of the plurality of target regions based on the workflow priority list; and
a network coupling the gateway and the one or more target region computing devices.

28. The system of claim 27, wherein the target region computing devices are further configured to remove the global data element upon detecting that the tranclass condition is resolved in the target region.

29. The system of claim 27, further comprising a coupling facility located between the gateway and the one or more target regions, the coupling facility configured to store the global data element.

30. The system of claim 27, wherein the one or more target region computing devices execute a long-running transaction to perform the detecting.
